(19) United States
(12) Patent Application Publication
(10) Pub. No.: US 2019/0112174 A1
(43) Pub. Date: Apr. 18, 2019

(54) Beverage Dispenser With Beverage Dispensing Containers And Method For Illuminating The Active Container

(71) Applicant: Pernod Ricard SA, Paris (FR)

(72) Inventors: Philippe Alix, Paris (FR); David Bersoult, Paris (FR)

(21) Appl. No.: 16/094,023

(22) PCT Filed: Apr. 13, 2017
(86) PCT No.: PCT/EP2017/059030

§ 371 Date: Oct. 16, 2018

(30) Foreign Application Priority Data
Apr. 18, 2016 (GB) 1606712.6

(51) Int. Cl. B67D 1/00; B67D 1/08; B67D 1/12; B67D 3/00

(52) U.S. Cl. CPC B67D 1/0004; B67D 1/0001; B67D 1/0875; B67D 2210/00034; B67D 1/0888; B67D 1/1229; B67D 3/0006; B67D 1/0877

(57) ABSTRACT

Method of controlling beverage dispensing system suitable for alcoholic beverages. A base unit comprises a control unit, a base-device transceiver in communication with the control unit and at least one visual indicator controlled by the control unit. At least one module is mounted in or on the base unit. The at least one module comprises a dispensing arrangement for dispensing beverage from a beverage reservoir. A computing devise configured to communicate with the base-device transceiver. The method comprises receiving an input from a user at the computing device and sending a dispense instruction signal to the control unit of the base unit via the base-device transceiver. In a dispense event, in response to the control unit of the base unit receiving the dispense instruction signal, at least one visual indicator is controlled to light up the at least one module for a predetermined time period based upon a fixed beverage flowrate and a desired beverage volume. The fixed beverage flowrate is the same for all dispense events relating to a particular module.

### TECHNICAL FIELD

This invention is directed towards a method of controlling a beverage dispensing system, which is particularly suitable for alcoholic beverages.

### BACKGROUND

Beverages, for example alcoholic beverages, sodas, concentrates and the like, are commonly supplied individually to consumers in bottles and typically glass bottles. However, glass bottles utilise space inefficiently when stacked, are relatively heavy and can be broken relatively easily when subjected to an impact. Therefore, they are not particularly suited to transportation. Furthermore, when a bottle is opened air is able to contact the beverage, which may result in the evaporation of the beverage and/or causing the beverage to degrade. For example, the alcohol in an alcoholic beverage will evaporate, thereby reducing the alcoholic content of the beverage. The air may also oxidise the alcohol such that the taste of the beverage changes.

Bag-in-box type containers commonly prevent air from contacting the beverage by comprising a one-way valve which allows beverage to flow out of, but prevents air from flowing into, the bag. However, such bag-in-box containers are not considered to be premium products by consumers and have, as a result, not replaced glass bottles as the typical beverage container.

WO-A-2015/101573 and WO-A-2015/101571 disclose beverage dispensing modules having dispensing means. The present invention is directed to addressing the aforementioned problems and providing an improved beverage dispensing system.

### SUMMARY OF INVENTION

The present invention provides a method and beverage dispensing system according to the claims.

The beverage dispensing module is suitable for containing alcoholic beverages and is particularly suitable for containing spirits, such as whisky, vodka, gin, liqueur, coffee liqueur, rum, aniseed-based spirit, pastis, cognac, brandy or tequila. The beverage dispensing container may also be suitable for containing other alcoholic beverages including champagne, wine, beer or cocktails, and/or other types of beverage, including sodas (also known as soft drinks) and beverage concentrates.

The present disclosure is directed towards a beverage dispensing apparatus in which at least one beverage dispensing module communicates with a base unit. In embodiments of a beverage dispensing system of the invention, the at least one beverage dispensing module and/or base unit is controlled from a mobile communication device or computing device via the base. Preferably the at least one beverage dispensing module is separable from the base unit and the beverage dispensing arrangement is operable to selectively dispense beverage independently of the base unit. The beverage dispensing arrangement may comprise a manually operable valve actuator arranged to, upon manual actuation thereof, selectively open the dispensing valve. Preferably the module comprises a pressurising arrangement for pressurising the reservoir such that beverage is ejected from the reservoir when the dispensing valve is open.

The present disclosure is further directed towards a user interface comprising a menu and a series of top level pages. The top level pages may comprise at least one of a beverage page, a host page, a base unit page, a shop page and an account page. The beverage page may display or provide links to a plurality of subpages and may also display the aforementioned module status visualisation. The subpages may comprise at least one of a recommendations subpage, a collections subpage, a favourites subpage, a library subpage and an ask subpage.

The present disclosure is further directed towards a method comprising the steps of: identifying at least one module located in or on a base unit; populating a present module data library with identifications of the at least one module; identifying available beverages based upon the present module data library and a beverage data library. The present module data library may be stored on the base unit and/or a computing device. The identifications of a module may include a type of beverage in the module. The beverage data library may be stored on a computing device and/or an external server. The beverage data library may comprise data relating to a plurality of beverage recipes. Each recipe may contain an identification of at least one beverage. Available beverages may be identified based upon the type of beverage in at least one module matching a beverage identified in a recipe.

### BRIEF DESCRIPTION OF THE DRAWINGS

By way of example only, embodiments of the present invention are now described with reference to, and as show in, the accompanying drawings, in which:

FIG. 1 is a view of the beverage dispensing system of the present invention;

FIG. 2 is a perspective view of a beverage dispensing module of the system of FIG. 1;

FIG. 3 is a side elevation of the module of FIG. 2 with a side wall hidden to show the internal arrangement of the module;

FIG. 4 is a perspective schematic view of a further embodiment of a beverage dispensing module illustrating a dispense sensing means;

FIG. 5 is a schematic of the beverage dispensing system of FIG. 1;

FIG. 6 is a front elevation of a beverage dispensing apparatus of the system of FIG. 1 with a schematic illustration of a control arrangement in a base unit; and

FIG. 7 is a schematic of a user interface of the present invention.

### DETAILED DESCRIPTION

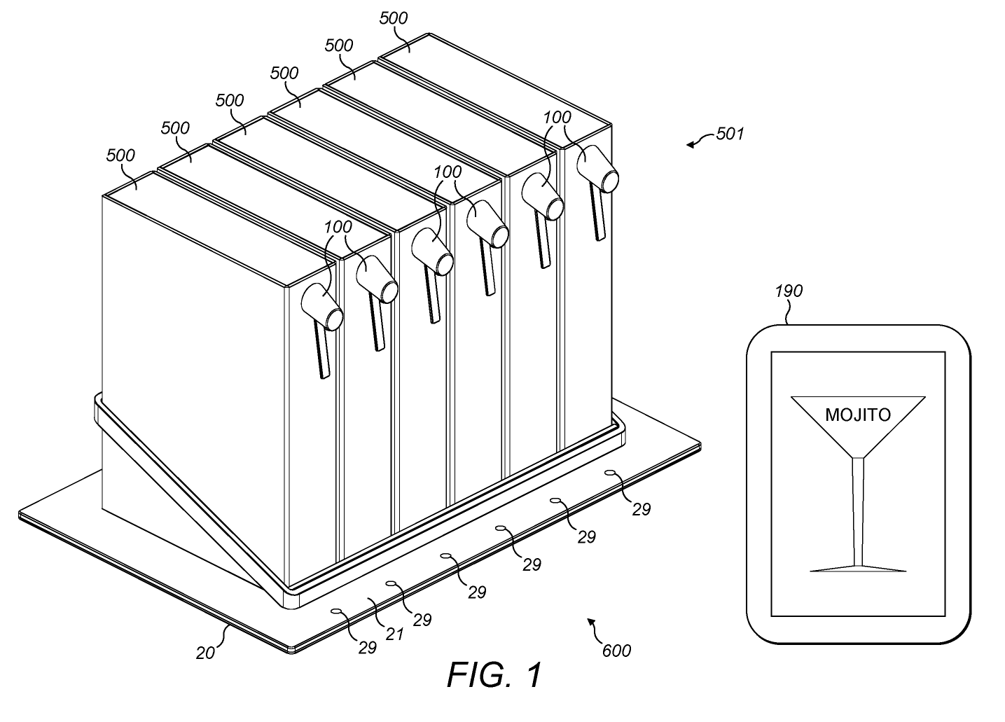

FIG. 1 illustrates an embodiment of the present invention in which a beverage dispensing system 600 comprises a beverage dispensing apparatus 501 and a computing device 190 configured with suitable software/applications to allow control of and/or communication with the beverage dispensing apparatus 501. The beverage dispensing apparatus 501 comprises a plurality of beverage dispensing modules 500 supported on or in a base unit 20. As illustrated, each module 500 may be supported adjacent to at least one other module 500 on a support surface 21 of the base unit 20. Each module 500 is also operable to stand on a surface independently of the base unit 20. Similar systems are disclosed in WO-A-2015/101573 and WO-A-2015/101571, which both of which are incorporated herein by reference.

### 1. The Beverage Dispensing Module(s)

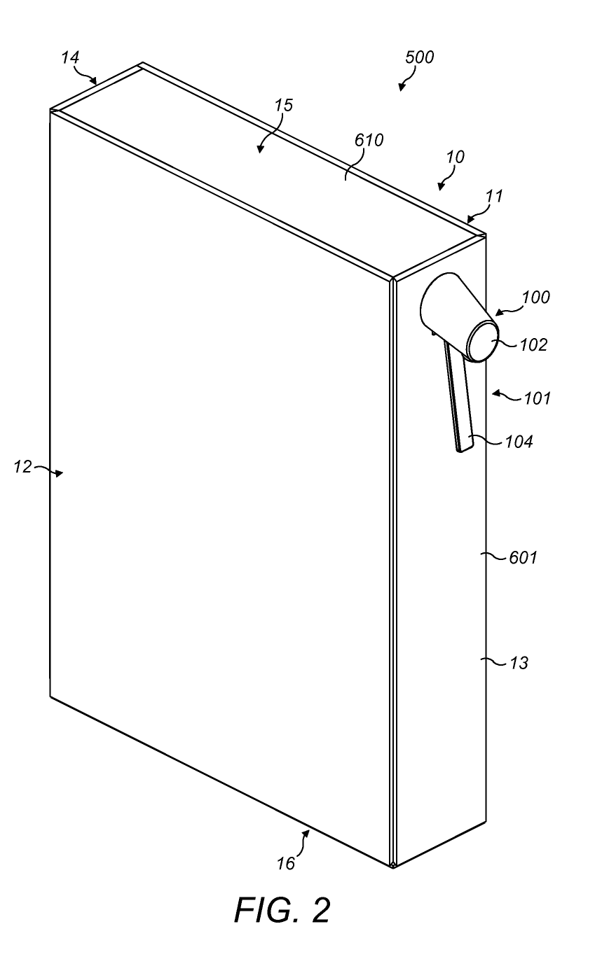

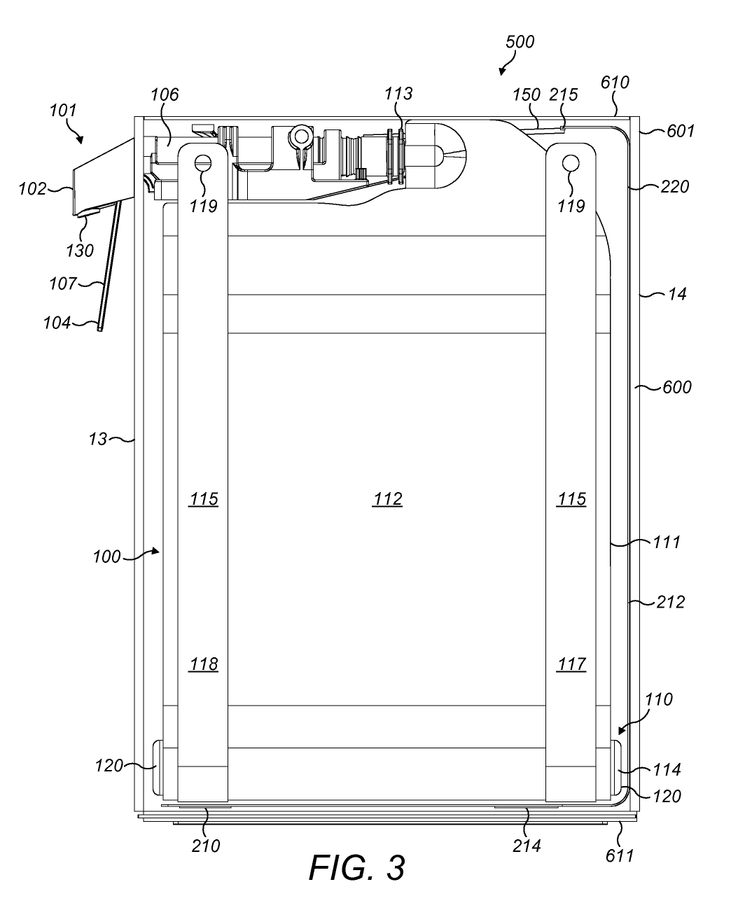

As illustrated further in FIGS. 2 and 3, each module 500 comprises a container 10 having first and second major side walls 11, 12, first and second minor side walls 13, 14 and first and second end walls 15, 16. The container 10 comprises a housing 601 and first and second end covers 610, 611.

The beverage dispensing module 500 further comprises a beverage dispensing arrangement 100. The beverage dispensing arrangement 100 comprises an outlet arrangement 101 for controlling liquid beverage flow or selectively dispensing liquid beverage from a beverage reservoir 111 located within the container 10. The outlet arrangement 101 comprises an outlet nozzle 102 mounted to the outside of the container 10 and a beverage dispensing valve 103 located at least partially within the container 10. The outlet nozzle 102 comprises an outlet aperture 130 at one end of an internal passageway. The beverage dispensing valve 103 is controlled by a manually actuatable dispensing actuator 104, for example in the form of a dispensing lever 107. The beverage dispensing valve 103 may comprise a ball valve. The beverage dispensing valve 103 is preferably not controlled automatically and is only manually actuatable.

The beverage dispensing arrangement 100 generally comprises a pressurising arrangement 110 for applying pressure to a compressible beverage reservoir 111 containing a beverage. Compressing the reservoir 111 causes the beverage in turn to flow along the outlet arrangement 101, which comprises the outlet nozzle 102, the dispensing valve 103 and a dispensing conduit 106 formed between the body of the reservoir 111 and the outlet nozzle 102. The beverage presses against the dispensing valve 103 until opened by the dispensing actuator 104, when beverage is driven from the reservoir 111, along the dispensing conduit 106, through the dispensing valve 103 and out of the container 10 via the outlet nozzle 102.

The reservoir 111 preferably comprises a pouch 112 formed of a flexible membrane having an outlet 113 connected and sealed to the outlet arrangement 101. The pressurising arrangement 110 comprises a roller 114 and a resilient bias means 115 or mechanism. An end of the pouch 112 is attached along the length of the roller 114. The resilient bias means 115 is arranged to roll the roller 114 such that the internal volume of the pouch 112 is reduced by wrapping the pouch 112 around the roller 114 as beverage is dispensed from the pouch 112. In the illustrated embodiments the resilient bias means 115 comprises first and second springs 117, 118, each attached at either end of the roller 114. However, it will be appreciated that the resilient bias means 115 could be in any other suitable form, for example comprising one or more elasticated members. In addition, the pressurising arrangement 110 could take any other form, such as a manually, electrically or mechanically driven pump or the like.

The module 500 further comprises dispensing valve sensing means 220 arranged to determine when the dispensing valve 103 is open or opened and provide a valve status signal indicative of whether the dispensing valve 103 is opened. The dispensing valve sensing means 220 may comprise any suitable arrangement for determining the status of the dispensing valve 103, whether directly by determining if the valve mouth is open or indirectly by determining the status of the dispensing actuator 104. In particular, the dispensing valve sensing means 220 may comprise a switch arrangement in contact with the dispensing valve 103 which is closed or opened upon movement of the dispensing lever 107.

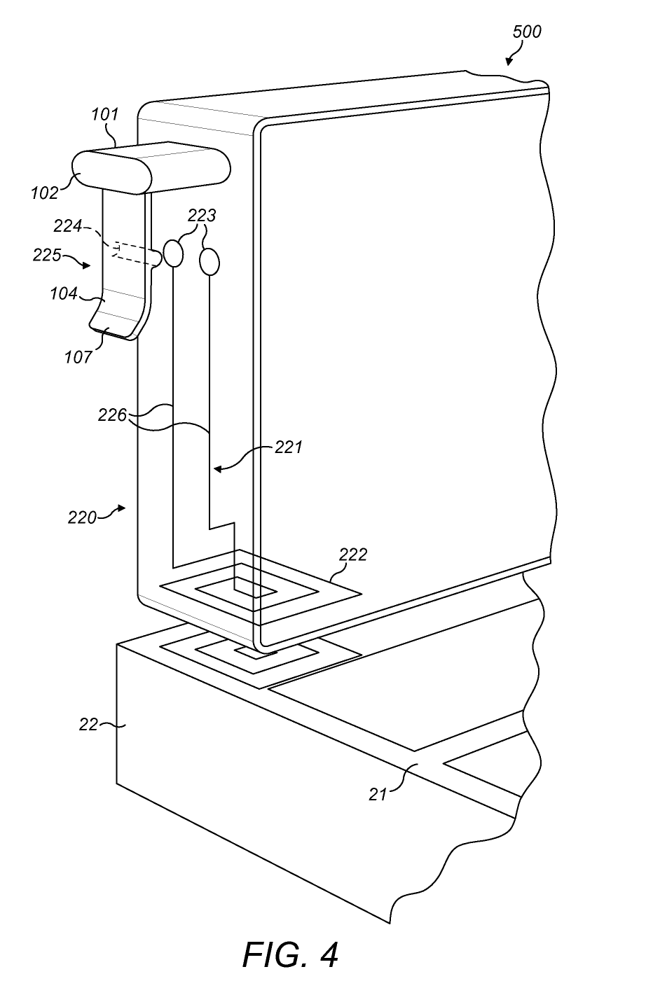

In the embodiment illustrated in FIG. 4, the dispensing valve sensing means 220 comprises an electric circuit 221 comprising a first communication means 222 connected via conductive elements 226 to separated contacts 223. The first communication means 222, which may be an antenna, RFID tag, NFC tag, inductive coil or the like, is mounted at the bottom of the module 500 on the inner face of the second end wall 16 adjacent to the base unit 20. The conductive elements 226 extend from the first communication means 222 along the inside of the container 10 from the second end wall 16 along the first minor side wall 13 and up to the separated contacts 223, which are provided in proximity to the dispensing lever 107 and on the outer face of the first minor side wall 13. Contact connection means 224, for example formed of a conductive backing, are provided on an inner side of the dispensing lever 107 in proximity to the separated contacts 223. The contacts 223 and contact connection means 224 form a switch 225, which, in the present embodiment, is closed when the dispensing actuator 104 is manually actuated as the lever moves the contact connection means 224 into contact with both of the contacts 223, thereby completing a circuit with the first communication means 222.

When the switches 225 are opened or closed the dispensing valve sensing means 220 are operable to provide a valve status signal indicative of whether the dispensing valve 103 is opened upon interrogation via the first communication means 222. For example, a current may be induced in the electric circuit 221 and the valve status signal may be indicative of whether the switch 225 is open or closed.

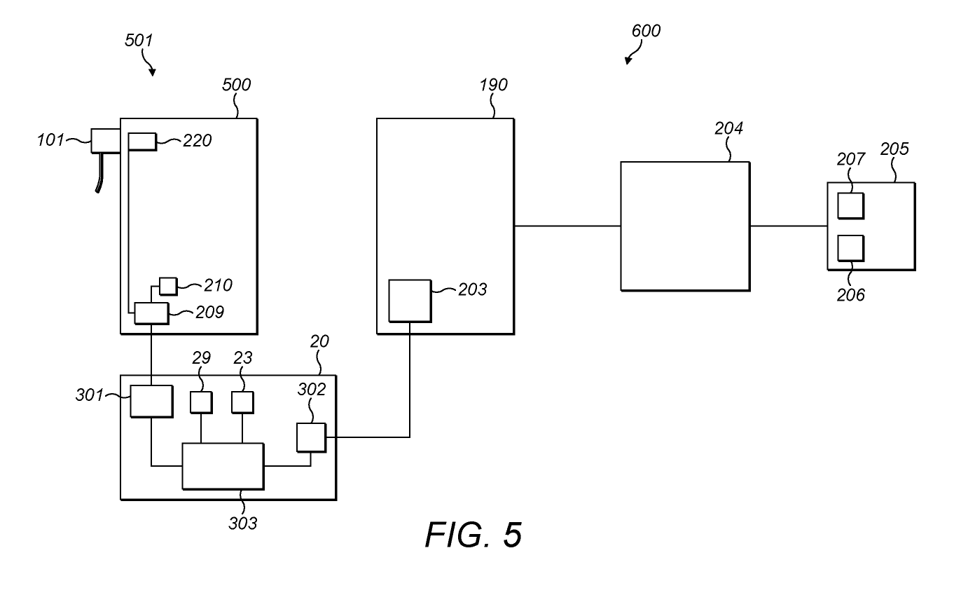

The module 500 further comprises a storage means 210 or a memory operable to store module data, the data being capable of being read by or communicated to the computing means 190 via communication means. The storage means 210 may be in communication with a dedicated second communication means of the module 500. However, in other embodiments, such as is illustrated in FIG. 5, the storage means 210 may be in communication with a shared communication means 209 with which the dispensing valve sensing means 220 communicates. The module data, being stored as static or dynamic content, relates to at least one of: beverage information relating to the type of beverage stored in the reservoir 111, the module history, module identification, the module weight, the dispense status, a predetermined time period and/or the like.

The dispense status data may comprise information relating to the current status of the dispensing valve 103. For example, the dispense status data may indicate if: the dispensing valve 103 is not dispensing, dispensing is starting, dispensing is occurring, dispensing is ending, the dispensing lever 107 is depressed but no beverage is being dispensed and/or the like.

The module weight data may comprise information relating to the weight and/or volume of beverage in the module 500. For example, the module weight data may include the weight of the module 500 when full, the weight of the module 500 when empty and the last weight measured by a base unit 20 when the module 500 was docked.

The storage means 210 and second or shared communication means 209 may be a passive, semi-active or active device or devices arranged to be interrogated by the base unit 20 and/or by the computing device 190. Preferably the storage means 210 is rewritable such that the module data thereon can be changed. However, certain embodiments of the present invention may comprise read-only storage means 210. The storage means 210 and second or shared communication means 209 preferably comprise an electronic tag, QR code, an RFID (radio-frequency identification) tag, an NFC (near field communication) tag, a WLAN (wireless local area network) interface and/or a Bluetooth (RTM) interface. The storage means 210 only provides the module data when interrogated by a power-providing reader (see below).

### 2. The Base Unit

In the beverage dispensing apparatus 501 illustrated in FIG. 1 the base unit 20 comprises a generally planar support surface 21 on which one or more modules 500 may rest. The support surface 21 is mounted to a lower housing 22. The base unit 20 may be sized for supporting any number of modules 500 in any suitable arrangement. In particular, the base unit 20 may comprise a plurality of module locations, each for supporting one module 500. Each mount may simply be defined by a surface area of the support surface 21 and is denoted by a marking or the like on the support surface 21. Alternatively, the module locations may comprise means for physically separating one module 500 from another such that a module 500 cannot overlap two module locations.

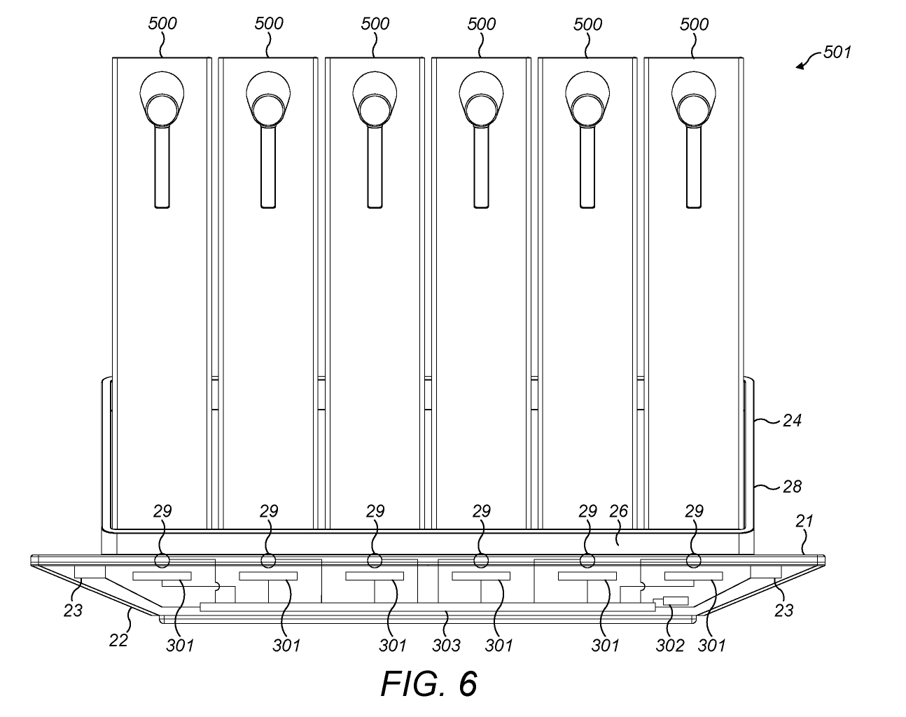

One or more load sensing means 23 for determining the amount of beverage remaining in each module 500 may also be provided. As illustrated in FIG. 6, the load sensing means 23 are preferably provided in the lower housing 22 and the support surface 21 is mounted to the load sensing means 23. Thus substantially all of the load of the support surface 21 is supported by the load sensing means 23, which can, therefore, detect the load on the support surface 21. In an alternative embodiment the support surface 21 may be formed of a plurality of separate surfaces for supporting a single module 500 and a load sensing means 23 may be provided under each separate surface for detecting the weight of a single module 500. In a preferred embodiment the load sensing means 23 are provided as one or more load cells. Suitable load sensing means 23 also include a dry contact sensor, piezo cells, a volumetric level sensor, a weight measuring sensor (e.g. a load cell), an ultrasonic level transmitter, a magnetostrictive or magnetic level transmitter, a capacitance transmitter, a float or a differential level transmitter. In yet a further alternative, the base unit 20 may comprise a plurality of feet upon which the lower housing 22 is mounted and these feet may comprise the load sensing means 23, such as in the form of load cells. The load sensing means 23 detect the total load on the base unit 20.

At least one visual indicator 29, for example in form of one or more LEDs, is also provided in the base unit 20 and is associated with each module location, and thus each module 500. Each visual indicator 29 may be located on the base unit 20 to direct a light upon one or more of the walls 11, 12, 13, 14 of a module 500 present on or in the base unit 20. In particular, each visual indicator 29 may comprise an RGB bulb which shines a white light onto each module 500. However, the RGB bulb may be operated to shine a different colour of light on each module 500 depending upon the status of the dispensing valve 103 and/or the volume of beverage inside the module 500.

The base unit 20 comprises at least one base-module transceiver 301 connected to an electronic circuit and operable to communicate with the first, second and/or shared communication means 209, 222 of one or more of the modules 500. The base-module transceiver 301 may comprise a number of different receiving and/or transmitting means for communication with the or each the first, second and/or shared communication means 209, 222. For example, the base-module transceiver 301 may comprise an RFID reader, an NFC reader, a Bluetooth (RTM) interface, a WLAN interface, an inductive sensor or the like.

Preferably a base-module transceiver 301 is provided for each module location such that each module 500 has a dedicated base-module transceiver 301. In a particular embodiment, as illustrated in FIG. 6, the base unit 20 comprises six base-module transceivers 301. Each base-module transceiver 301 comprises a first transceiver for reading and writing to the storage means 210 of a module 500 via the communication means 209, 222. Each base-module transceiver 301 comprises a second transceiver for communicating with the dispensing valve sensing means 220.

In a particularly preferred embodiment, the storage means 210 may comprise an NFC tag, which also forms the second communication means 201, and the dispensing valve sensing means 220 may comprise one of the aforementioned electric circuits 221, including the switch 225 and a wire coil, which forms the first communication means 222. The first transceiver comprises an NFC transceiver for communicating at approximately 13.56 MHz and the second transceiver comprises an inductive sensor for communicating at approximately 200 MHz. In yet a further embodiment, only a single base-module transceiver 301, including a multiplexer and a plurality of antennae, may be provided for communication with all modules 500 located on or within the base unit 20.

The second transceiver may comprise an analog electronic circuit that comprises a coil for location in the base unit 20 adjacent to the dispensing valve sensing means 220 of a module 500 mounted on the base unit 20. The coil is connected to an amplifier, which may be a standard differential amplifier, for amplifying the signal detected by the coil. The amplifier may be connected to a logical gate, such as a comparator and latch, which provides a digital signal indicating the dispensing valve status signal as high or low, each of which may indicate that the dispensing valve 103 is open or closed. This high or low signal is sent to a control unit (see below). The analog electronic circuit may be a resonant LC oscillator in which the operation of the switch 225 of the dispensing valve sensing means 220 results in a reduction in source inductance and thereby results in a change in the resonant frequency of the oscillator. The comparator amplifies and buffers the oscillator output to a full scale range. Preferably the oscillator is running at all times since the oscillator may have a relatively long start-up time. Multiple samples may be required to detect the change in source inductance.

The base unit 20 further comprises a control unit 303 in communication with the load sensing means 23, at least one base-module transceiver 301 and at least one visual indicator 29. A pulse width modulation arrangement may be provided within or connected to the control unit 303 for controlling the at least one visual indicator 29. The control unit 303 is also operable to rapidly issue and receive signals to/from each base-module transceiver 301 sequentially within 200 ms.

The control unit 303 preferably comprises one or more processing units, and a real time clock for data logging. The processing units may operate in accordance with a set of instructions in the form of firmware stored on a memory. A power supply, in the form of rechargeable batteries and a mains supply, is also connected to provide power to the control unit 303. A number of input devices, such as switches or buttons, may be located in or on the base unit 20 and connected to the control unit 303 for providing an input to the control unit 303.

The control unit 303 further comprises a memory for storing data relating to individual modules 500, and particularly the module data stored on the storage means 210 of each module 500 and/or the firmware. Thus, for a plurality of modules 500, the memory of the control unit 303 may further store data including at least one of the aforementioned: beverage information relating to the type of beverage stored in the reservoir 111, the module history, module identification, the module weight, the dispense status and/or the like. The module data stored by the memory relating to the plurality of modules 500 on the base unit 20 will be referred to herein as the “present module data library”.

The base unit 20 further comprises a base-device transceiver 302 connected to the control unit 303 for enabling communication from the control unit 303 to the computing device 190. Preferably the base-device transceiver 302 is arranged to wirelessly exchange information between the control unit 303 and the computing device 190. For example, the base-device transceiver 302 comprises a WLAN interface, Bluetooth™ receiver/transmitter, a wifi (wireless) transmitter/receiver, a mobile data transceiver, an NFC transceiver or otherwise.

It will be appreciated that, although the control unit 303, base-device transceiver 302, visual indicators 29, base-device transceiver 302, load sensing means 23 and power unit have been described separately, they may all be integrated into single circuits and/or the like. Furthermore, each component may be mounted in a suitable manner within the base unit 20.

### 3. The Computing Device

FIG. 5 illustrates in schematic form the manner in which the module 500, and base unit 20, of the beverage dispensing system 600, and the portable computing device 190, communicate with one another so as to allow a user to control the dispensing of beverage from the module 500.

Although the computing device 190 is shown as a portable device separate from the base unit 20 and comprising a tablet computer or a smart phone, in other embodiments (not shown), the computing device 190 may instead comprise a dedicated hardware unit having software operable solely to control and/or communicate with the base unit 20. The computing device 190 could be formed integrally with the base unit 20 with some form of input means (such as a touch screen) to allow a user to input instructions to the beverage dispensing system 600. The computing device 190 may comprise a personal computer, a tablet computer, a mobile telephone or a dedicated portable handset. For example, the computing device 190 might comprise or include one or more of a processor, a RAM, a ROM or other memory, a display device, one or more input/output devices and communication means between them. The memory preferably stores at least one of network browser software, website content, application software, the present module data library, a beverage data library (see below), user profiles, advertising content, a link and/or the like.

The content relating to a user profile includes one or more of each of, or a combination of: user identification, user contact details, user preferred payment information, user preferences, user history and a user's present module data library. The user history may include at least one of: previous purchases of beverages and/or related products, previous use of the beverage dispensing system 200, previous consumption rate of beverage from modules 500, previous mixes of beverages made from modules 500 and/or the like.

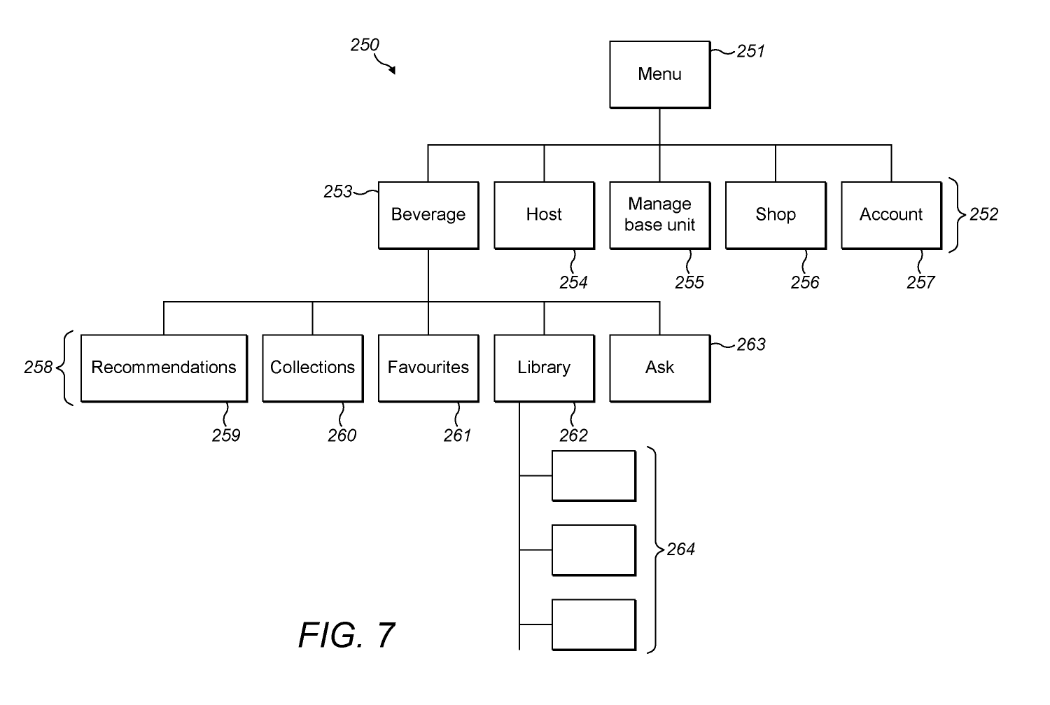

In use, in the preferred embodiment illustrated in FIGS. 5, the appropriate software application is run upon the computing device 190. This acts as a user interface 250, further details of which will be set out below in relation to FIG. 7, to allow a user to interactively communicate with the base unit 20. Particularly preferred user interface schemes provide for the computing device 190 to interact with, separately, multiple modules 500 each positioned upon the base unit 20 and each containing different alcoholic and/or non alcoholic beverages. In this manner, the user may interact with the computing device 190 to allow the creation of cocktails and other mixtures of the various beverages available in the multiple modules 500 on the base unit 20.

The computing device 190 comprises a wireless transceiver 203 for communication with the base-device transceiver 302. This may be, for example, a Bluetooth™ receiver/transmitter, a wifi (wireless) transmitter/receiver, a mobile data transceiver, an NFC transceiver or otherwise. The wireless transceiver 203 in the computing device 190 is preferably configured to communicate with the base-device transceiver 302 in the base unit 20.

The computing device 190 is also optionally connected to and operable to transfer data with a network 204, for example the Internet. One or more computer servers 205 may also be connected to the network 204. Each server 205 comprises a memory 207, the memory 207 storing one or more databases 206. The memories 207 and/or database(s) 206 of the one or more servers 205 host at least one of network browser software, website content, application software, user profiles, advertising content and/or the like. The memories 207 and/or database(s) 206 preferably further store any of the aforementioned data stored on the base unit 20 and modules 500. The present module data library stored on the memory of the control unit 303 may be replicated on the servers 205. Thus, for each module 500, the memories 207 and/or database(s) 206 may further store data including at least one of: beverage information relating to the type of beverage stored in the reservoir 111, advertising content, a link, the module history, module identification, the module weight, the dispense status, flow rates and/or the like.

Furthermore, the servers 205 may further store a beverage data library, which contains recipes and instructions for forming a plurality of beverages (such as alcoholic cocktails). The beverages may be mixed beverages, which have at least two components thereto; including mixtures of alcoholic beverages, non-alcoholic beverages, food products and associated suitable drinking vessels (e.g. a whisky glass or cocktail glass). The beverage data library may store, for each beverage, at least one of a name, beverage type, alcohol composition, mage, popularity value, collection, theme, taste, mood, skill valve and suitable drinking vessel. Such data could be stored upon the computing device 190, as a part of the application data of the software running on that, or even elsewhere such as in cloud storage or a server 205 connected to a network 204 (see below).

### 4. System Operation

The control unit 303 is operable to control the outputs of the at least one visual indicator 29, the at least one base-module transceiver 301 and the base-device transceiver 302. The control unit 303 of the base unit 20, via the at least one base-module transceiver 301 and first, second and/or shared communication means 209, 222 of one or more of the modules 500, is operable to receive the data on the storage means 210 and the valve status signal. The control unit 303 is also operable to receive load data from the load sensing means 23 and, if present, inputs from the input devices.

The beverage dispensing system 600 is arranged to perform a number of operations. As will be appreciated from the following description, one or more of the operations may be implemented simultaneously and some operations require the implementation of one or more other modes in order to be implemented.

In a module presence operation it is determined whether a module 500 is or is not present and/or has been added to or removed from each module location of the base unit 20. In this operation the control unit 303 attempts to communicate with the storage means 210 or dispensing valve sensing means 220 to detect their presence. The control unit 303 is arranged to store such presence on its memory and any changes in the presence are logged as an addition/removal of a module 500.

In a module-base storage operation the control unit 303 reads at least part of the module data on each module 500 and stores it on its memory in the present module data library. The control unit 303 may also write new module data from the present module data library to the storage means 210 on each module 500. In this operation the communication occurs between the storage means 210 and control unit 303 via the communication means 201, 214, 222 and base-module transceiver 301.

In a module dispense status operation the control unit 303 determines whether a module 500 is dispensing a beverage. In this operation the control unit 303 interrogates the dispensing valve sensing means 220 via each base-module transceiver 301 and receives the dispensing valve status signal indicative of whether the dispensing valve 103 is open. This interrogation may be repeated continuously or rapidly (particularly if the base-module transceiver 301 comprises an inductive sensor) in order to be able detect immediately when the dispensing begins and ends. The control unit 303 stores the status of the dispensing valve 103 (i.e. dispensing, not dispensing) on its memory in the present module data library. The control unit 303 also stores, in the present module data library, the time of the start and the end of a dispense event and may determine how long the dispense event lasted. This data may also be written to the storage means 210 of the relevant module 500 using the module-base communication mode.

In a load detection operation the control unit 303 determines the total load of the modules 500 place on/in the base unit 20 using the outputs from the load sensing means. This load data is stored in the memory of the control unit 303. It may be necessary to only store the load data after a period of time such that the output from the load sensing means has stabilised. This will, for example, avoid load determinations when pressure is applied by a user to the base unit 20 when adding a module 500 thereto.

In a module beverage amount determination operation the weight/volume of beverage remaining in each module 500 mounted in or on the base unit 20 is determined. In this operation the control unit 303 utilises the data stored from the module presence operation, module dispense status operation and load detection operation. The weight/volume data is stored on the memory of the control unit 303 and may also be written to the storage means 210 of the relevant module 500 using the module-base communication mode. It will be appreciated that, given that the density of the beverage is known by the control unit 303, the weight of beverage remaining is interchangeable with the volume and in the following description “weight” may be interchanged with “volume”.

In a remaining beverage amount visualisation the control unit 303 operates the output of the visual indicators 29 to indicate the remaining beverage weight/volume in a module 500. For example, if the remaining weight/volume is below 10% of the full capacity of the module 500 then the visual indicator 29 may be switched on. In particular, an LED may shine upon the module 500. Alternatively, the control unit 303 may change the output of the visual indicator 29 dependent upon the level of beverage in a module. For example, a light which changes colour and/or intensity could be employed.

In a dispense instruction operation, described in further detail below, certain modules 500 are highlighted for manual operation by a user using the at least one visual indicator 29. The control unit 303 controls the output of the at least one visual indicator 29 in accordance with instructions received from the user interface 250 on the computing device 190.

In a base-device communication operation data is communicated between the computing device 190 and control unit 303. For example, the data stored in the present module data library is communicated to the computing device 190. Data relating to the dispense instruction mode may be communicated from the computing device 190 to the control unit 303.

In a network communication operation the computing device 190 exchanges data with the servers 205 or the like on the network 204.

In a user interface operation the computing device 190 implements a user interface 250 for receiving inputs from a user, communicates with the server 205 via the network communication operation and exchanges data with the base unit 20 via the base-device communication operation.

### 5. User Interface

In the user interface operation the computing device 190 operates a network browser or application on the computing device 190 which provides a user interface 250. The user interface 250 enables the user to interact with a website or the application. FIG. 7 illustrates a particular embodiment of the structure of a user interface 250 that can be operated by a manual input from a user (e.g. via an input device, such as a touch screen, of the computing device 190). The manual input from the user may result in the user interface 250 switching between a menu 251 and a plurality of pages or interfaces. In order to access the menu 251 and/or pages the user may need to provide identification details, such as a username and password, to load data relating to an associated user profile from the servers 205 via the network communication operation to the computing device 190 for use in operation of the user interface 250.

The menu 251 may display links, each of which a user can select via the input device, to a series of top level pages 252, which may include a beverage page 253, a host page 254, a base unit page 255, a shop page 256 and an account page 257. Each top level page 252 may comprise at least one link directing a user to a plurality of further pages. Each of the pages may provide opportunities for a user to provide a manual input to perform different operations, particularly those discussed above, of the beverage dispensing system 600. For example, in response to a manual input the computing device 190 may implement a base-device communication operation and receive data from the base unit 20. Alternatively, the computing device 190 may download or upload content from/to the one or more server(s) 205 via the network communication operation.

The base unit page 255 may display information relating to the status of the module(s) 500 and base unit 20. The computing device 190 is operable to receive, via the base-device communication operation, all data stored on the control unit 303, such as that in the present module data library, and on storage means 210 on any module 500 present on the base unit 20. The computing device 190 may then display this information for the user on its display device. In a module status visualisation, the base unit page 255 may display the information relating to each beverage type present in the modules 500 on the base unit 20 and may display the position of modules 500 of different beverage types on the base unit 20. In particular, the computing device 190 is arranged to display the data relating to at least one of the type of beverage in each module 500 on the base unit 20, the beverage amount remaining in each module 500 (i.e. the output from the module weight/volume determination operation) and an indication as to whether a dispensing valve 103 of a module 500 has been actuated (i.e. the output from the module dispense status operation). The computing device 190 may also display a history of use of the modules 500 mounted on the base unit 20, which may be associated with a user profile. The information relating to each module 500 may be visible separately and/or together with the information relating to other modules 500.

The computing device 190 may also display, in a base unit status visualisation, the amount of battery remaining in the power supply of the base unit 20, whether there are any errors in the base unit 20 and any other information relating to the base unit 20. The base unit page 255 may also provide a link to update the firmware on the control unit 303 of the base unit 20. In particular, the computing device 190 may commence the network communication operation to check whether there are any firmware updates available to download from the servers 205. If available, the computing device 190 may subsequently download a firmware update and communicate it to the base unit 20 via the base-device communication operation. The control unit 303 may subsequently update its firmware and return a message to the computing device 190 indicating that the control unit 303 has been updated. This message may be displayed to the user on the computing device 190. In a similar manner, the progress of the update may be displayed on the computing device 190 during updating of the firmware. Prior to updating the firmware, the computing device 190 and/or control unit 303 may run a series of logical checks to ensure that the control unit 303 meets the necessary specifications for the installation of the firmware update.

The account page 257 may provide access to links and/or display content relating to a user profile. The account page 257 may provide the user with the opportunity to amend the user profile content. The computing device 190 may communicate user profile content with the servers 205 for such display and amendment.

The shop page 256 may provide an online ordering function through which the user can order further modules 500 and other accessories. In particular, the computing device 190 may provide information relating to a plurality of modules 500 and accessories available for purchase, which may be downloaded from the servers 205, and the user can select one or more of the modules 500 for purchase. Upon purchase of an order, the computing device 190 may communicate with at least one payment server, which may be different to the servers 205 hosting the user profile content, to receive payment based upon the user preferred payment information. The computing device 190 may communicate with the servers 205 upon purchase to store the details of the order. The stored order details may subsequently be accessed for shipping the order to the user.

The host page 254 may include means for assisting a user in hosting an event. In particular, the host page 254 may enable a user to activate a social networking function for connecting the user to one or more social networks. The user may be able to view user profiles of a second user and view the history of beverages purchased by the second user. The user may subsequently be able to identify beverages that the second user may prefer and purchase further modules 500 for consumption at an event.

The beverage page 253 may display links to a plurality of subpages 258 and may also display the aforementioned module status visualisation. The computing device 190 may further download and display on the beverage page 253 editorial content, such as website content and advertising content, from the server 205. The subpages 258 may comprise one or more of a recommendations subpage 259, a collections subpage 260, a favourites subpage 261, a library subpage 262 and an ask subpage 263. The beverage page 253 may further display summaries of information that would be displayed on the subpages 258; for example, the beverage page 253 may display information relating to a recommended beverage, a beverage in a stored collection or favourite beverage from the user profile. Alternatively, all of the subpages 258 may be integrated into a single beverage page 253.

The recommendations subpage 259 may provide suggestions to a user as to beverages that can be made utilising the beverage types in the modules(s) 500 present on the page. In particular, the computing device 190 may compare the present module data library (i.e. information of the modules 500 on the base unit 20) with the beverage data library (i.e. information for forming beverages), which may be downloaded from the servers 205 and/or stored on the computing device 190. The computing device 190 may subsequently determine an available beverage set, which is a list of the beverages in the beverage data library that can be formed using the modules 500 of the present module data library.

From this available beverage set, the computing device 190 may display at least one available beverage as a recommendation to a user. The recommendation may be random and based upon the available modules 500 of the present module data library. The recommendation is, however, preferably based upon the beverage history associated with a user profile. In particular, the recommendation may be a beverage the user has previously consumed, a beverage with a similar taste to a previously consumed beverage, a beverage with a similar alcohol content to a previously consumed beverage, a beverage with a similar effect (such as similar colours or temperatures) to a previously consumed beverage, a beverage formed with the same non-alcoholic or non-liquid components (e.g. different food products, ice, fruits etc) as a previously consumed beverage or the like. Alternatively, certain beverages may be associated with certain times of day in the beverage data library and the recommendations may be based upon the time of day and these certain beverages.

The recommendations may also be based upon the volume of beverage remaining in each module 500. For example, if a module 500 only has 50 g of beverage remaining then the recommendation subpage 259 may not indicate a mixed beverage requiring 100 g from that module 500. However, the recommendation subpage 259 may indicate that a drink requiring 50 g can be made.

The recommendations may also be associated with a beverage difficulty value stored in the beverage data library. The beverage difficulty value may indicate the complexity and/or skill required in the creation of a certain beverage (particularly a mixed beverage). The computing device 190 may, therefore, compare a user skill value, indicative of the beverage making skills of the user, stored in the user profile with the beverage difficulty value and only recommend beverages matching the user skill value. Alternatively, the recommendation subpage 259 may display the beverage difficulty value for the user to assess independently whether they are capable of forming the beverage.

The collections subpage 260 may display to the user different editorial content relating to beverages stored in the beverage data library. In particular, the beverages may be displayed according to themes stored in the beverage data library. Themes may include beverage types, beverage brands, beverage contents and the like.

The favourites subpage 261 may display beverages identified by the user and stored with their user profile. In particular, when recommended a particular beverage on the recommendations subpage 259 or upon viewing a particular beverage in the library subpage 262 (see below), the user may be provided with an option to provide an input to store an identification of the particular beverage in their user profile. These stored particular beverages may subsequently be displayed on the favourites subpage 261.

The library subpage 262 may provide a beverage information interface in which a user can view and search for all of the beverages stored in the beverage data library. The beverage information interface may comprise beverage subpages 264 on which further information relating to a certain beverage may be viewed by the user. The beverage subpage 264 may also be accessible via links on the beverage page 253, host page 254, base unit page 255, shop page 256 and/or subpages 258. The beverage information interface may be operable to display beverages according to a collection or other such theme. Furthermore, each beverage may have an associated popularity value and the beverage information interface may be operable by a user to display the beverages according to the popularity values. The popularity values may be defined by inputs from a plurality of users and/or by the popularity of purchasing the beverages. The popularity values may also be determined via social networks and the like.

The ask subpage 263 may comprise means by which a user can input certain data and the computing device 190 may subsequently suggest a recommended mixed beverage. For example, the data provided by the user may be associated with ingredients the user does not enjoy, the mood the user is in, the alcohol types and/or strengths the user prefers, the skill value of the user, the type of drinking vessels available to the user and the like. The user may also be able to input the types of food products and/or beverages available to the user. The data can, in addition to or alternatively to the input from the user, be populated from data stored with the user profile.

The user may also be provided, on each of the subpages 258 and/or beverage subpages 264, with a means to provide an input to implement an instructor function to display a step-by-step guide for creating a mixed beverage. The instructor function is discussed in further detail below.

The computing device 190 may store to the user profile the beverages selected for preparation by the user via the instruction function, thereby recording such a history. The user profile may be stored on the servers 205 and/or computing device 190. The data captured from each user stored in the database(s) 206 may be combined with that of other users in order to assess global preferences and the like. In particular, data from a plurality of users relating to consumption frequency, favourite beverages and the like may be populated into an anonymous data set for analysis.

The computing device 190 may also be operable to display, via the user interface 250, errors associated with the module(s) 500 and base unit 20. Such errors might include the lack of any modules 500 on the base unit 20, a lack of beverage remaining in any one of the modules 500 located on the base unit 20, an inability to measure the volume remaining in one or more of the modules 500 located on the base unit 20, an inability to recognise the communication means 209, 220 of one or more modules 500 (such as via incorrect positioning) and the like. Such errors may be recognised via instructions stored in the control unit 303 of the base unit 20 and communications to the computing device 190.

The computing device 190 may further be connected via the network 204 to one or more push notification services on a server 205. Such push notification services may be configured to send messages to the user via the user interface 250.

### 6. Instructor Function

The instructor function coaches a user through the preparation of a mixed beverage based upon the beverage types in the modules 500 on the base unit 20. The instructor function may indicate preferred presentations of the beverage type, such as temperature and/or drinking vessel type (e.g. type of glass). The instructor function may also indicate any foods with which the beverage type is preferably consumed.

The user may provide an input to select a beverage which can be made in the instructor function via a link on each of the subpages 258 and/or beverage subpages 264. The selected beverage is from the available beverage set. The computing device 190 may subsequently download a set of instructions from the servers 205 or load the instructions from its memory. The instructions may comprise a recipe for forming the selected beverage. The computing device 190 may subsequently display the recipe to the user via the user interface 250. Preferably the recipe comprises a plurality of recipe steps and each recipe step is displayed to the user sequentially. Each recipe step may be displayed on different recipe step subpages and the user may provide an input to move between each recipe step subpage. Each recipe step may comprise at least one of preparing food products, preparing a suitable drinking vessel, pouring a suitable volume of one or more beverages into the drinking vessel, locating food products in the beverage in the drinking vessel, preparing a suitable presentation of a beverage, serving the beverage and the like.

In a pour recipe step the user may be instructed to dispense beverage from one or more the modules 500. Either automatically (e.g. when the pour recipe step subpage is viewed by a user) or upon instruction from a user, the beverage dispensing system 600 may implement the dispense instruction operation and dispense instructions are issued from the computing device 190 to the control unit 303 in the base unit 20. The dispense instructions may relate to an identified module 500. The computing device 190 may also communicate data relating to a predetermined time period to the base unit 20 and/or the base unit 20 may obtain data relating to the predetermined time period from its memory or one or more modules 500.

Based upon the dispense instructions and predetermined time period, the control unit 303 operates one or more visual indicators 29 associated with one or more modules 500. The visual indicators 29 may highlight one or more modules 500 sequentially in order to indicate to a user how to make a mixed beverage. For example, the visual indicators 29 may direct a light onto at least one of the first and second major side walls 11, 12, first and second minor side walls 13, 14 and first and second end walls 15, 16 of the module 500.

The user places a drinking vessel adjacent to the module 500 being highlighted by the visual indicator 29 and manually actuates the dispensing lever 107 to dispense beverage from the module 500 in a dispense event. The module dispense status operation detects the actuation and records the start time of the dispense event. Upon reaching the end of the predetermined time period, or just before the end, the control unit 303 operates the at least one visual indicator 29 to indicate that the user should stop actuating or holding the dispensing lever 107 to stop dispensing beverage and end the dispense event. For example, the visual indicators 29 may be switched off or may change colour.

During the dispense event the at least one visual indicator 29 may indicate that the end of the predetermined time period is approaching. For example, the control unit 303 operates the at least one visual indicator 29 to increase or decrease its brightness as the end of the predetermined time period is approached. In addition, during the dispense event, the user interface 250 may be arranged to provide a certain display to the consumer when a dispensing valve 103 has been opened on one or more of the modules 500.

The control unit 303 may record the end of the predetermined time period and the end of the dispense event and communicate these statuses with the computing device 190. The computing device 190 may subsequently operate the user interface 250 to display a subsequent recipe step subpage.

If beverage from several modules 500 is to be used in the creation of the mixed beverage, a plurality of dispense instructions relating to different modules 500 may be communicated from the computing device 190 to the base unit 20. The base unit 20 may subsequently highlight each module 500 in accordance with the recipe steps, each for a predetermined time period. In particular, the highlighting of the next module 500 may begin once dispensing from the first module 500 has finished. The preset time period for dispensing from the next module 500 may start once the user actuates the dispensing lever 107 of the subsequent module 500.

The predetermined time period is preferably calculated based upon a fixed beverage flowrate value and a desired beverage amount. The desired beverage amount may be the mass or volume of beverage required in a recipe step for forming a beverage. The fixed beverage flowrate value may be unrelated to an actual or current flowrate from any one module 500. The fixed beverage flowrate value may be stored on the module 500, control unit 20, computing device 190 and/or server(s) 205. For example, the fixed beverage flowrate may be 1 second per 10 ml of beverage required. Thus, for a desired beverage volume of 120 ml, the predetermined time period may be 12 seconds.

The fixed beverage flowrate value may be determined based upon testing the actual flowrate in a plurality of dispense events of a plurality of modules 500. The fixed beverage flowrate may be the same for a plurality of dispense events, a plurality of beverages in the beverage data library and/or a plurality of modules 500. In particular, the fixed beverage flowrate may be the same for all dispense events relating to a particular module 500. The fixed beverage flowrate may be the same for all dispense events relating to a particular set of modules 500, the set of modules 500 containing the same beverage. Furthermore, the fixed beverage flowrate may be the same for a plurality of sets of modules 500 (i.e. such that the same fixed beverage flowrate applies to different beverages) and may be the same for substantially all modules 500 available for use in the system 600.

The use of a fixed beverage flowrate value may be particularly advantageous over attempting to set the predetermined time period according to an actual flowrate. This may be because detecting an actual flowrate using the load detection operation can result in incorrect measurements, particularly when a user exerts an additional force which cannot be identified and excluded by the base unit 20. Furthermore, using a fixed beverage flowrate value significantly simplifies operation of the base unit 20 during the instructor function, thereby reducing battery consumption and necessary computing power.

1. A method of controlling a beverage dispensing system comprising a base unit comprising a control unit, a base-device transceiver in communication with the control unit and at least one visual indicator controlled by the control unit; at least one module mounted in or on the base unit, the at least one module comprising a dispensing arrangement for dispensing beverage from a beverage reservoir; and a computing device configured to communicate with the base-device transceiver, said method comprises the steps of:
receiving an input from a user at the computing device;
sending a dispense instruction signal to the control unit of the base unit via the base-device transceiver; and
in a dispense event, in response to the control unit of the base unit receiving the dispense instruction signal, controlling the at least one visual indicator to indicate the at least one module for a predetermined time period, the predetermined time period being based upon a fixed beverage flowrate and a desired beverage volume, wherein the fixed beverage flowrate is the same for all dispense events relating to a particular module.

2. A method as claimed in claim 1 wherein the fixed beverage flowrate is the same for all dispense events relating to a particular set of modules, the set of modules containing the same beverage.

3. A method as claimed in claim 2 wherein the fixed beverage flowrate is the same for a plurality of sets of modules.

4. A method as claimed in claim 1 further comprising the steps of:
starting a countdown of the predetermined time period upon determining that a dispensing valve has been manually opened by the user; and
upon expiry of the predetermined time period, controlling the at least one visual indicator to change an indication by the at least one visual indicator.

5. A method as claimed in claim 4 further comprising, upon expiry of the predetermined time period, controlling the at least one visual indicator to stop indicating the at least one module.

6. A method as claimed in claim 4 wherein the at least one module further comprises valve sensing means operable to determine whether the dispensing valve is open and the method further comprises the step of communicating a valve status signal indicative of whether the dispensing valve is open to the control unit of the base unit.

7. A method as claimed in claim 6 wherein the at least one module further comprises communication means in communication with the valve sensing means and arranged to receive the valve status signal and the base unit comprises a base-module receiver operable to communicate with the communication means of one or more modules to receive the valve status signal and communicate the valve status signal to the control unit of the base unit.

8. A method as claimed in claim 4 wherein the base unit further comprises load sensing means in communication with the control unit and arranged to determine a total weight of the at least one module mounted in or on the base unit, and the method further comprises the steps of:
determining a change in the total weight of the at least one module; and
determining that the dispensing valve is open based upon the change in total weight of the at least one module.

9. A method as claimed in claim 1 wherein the base unit comprises at least a first and a second visual indicator and at least a first and a second module are provided, wherein the method comprises the steps of:
in a first dispense event, in response to the control unit of the base unit receiving the dispense instruction signal, controlling the first visual indicator to indicate the first module for a predetermined time period,
in a second dispense event, after a first instructor event, controlling the second visual indicator to indicate the second module for a predetermined time period.

10. A method as claimed in claim 1 further comprising the step of storing the predetermined time period and/or fixed beverage flowrate on a member selected from the group consists of: a memory of the base unit, at least one module or computing device.

11. A method as claimed in claim 1 further comprising:
running a user interface on the computing device; and
controlling output of the plurality of visual indicators based upon inputs into the user interface on the computing device.

12. A method as claimed in claim 11 further comprising:
receiving an input relating to a selected beverage on the user interface;
displaying at least one recipe subpage, associated with the selected beverage, on the user interface; and
in response to the display of a pour recipe step subpage, or in response to an input to the user interface, issuing dispense instructions from the computing device to the control unit.

13. A beverage dispensing system comprising:
a base unit comprising a control unit, a base-device transceiver in communication with the control unit and at least one visual indicator controlled by a control unit;
at least one module mounted in or on the base unit, the at least one module comprising a dispensing arrangement for dispensing beverage from a beverage reservoir; and
a computing device configured to communicate with the base-device transceiver.
